(19) United States
(12) Patent Application Publication
(10) Pub. No.: US 2025/0102955 A1
(43) Pub. Date: Mar. 27, 2025

(54) DEVELOPING DEVICE AND IMAGE FORMING APPARATUS

(71) Applicant: FUJIFILM Business Innovation Corp., Tokyo (JP)

(72) Inventors: Wataru SUZUKI, Kanagawa (JP); Yasuki TANAKA, Kanagawa (JP); Yuki YOKOYAMA, Kanagawa (JP)

(73) Assignee: FUJIFILM Business Innovation Corp., Tokyo (JP)

(21) Appl. No.: 18/442,123

(22) Filed: Feb. 15, 2024

(30) Foreign Application Priority Data
Sep. 26, 2023 (JP) 2023-163136

(51) Int. Cl. G03G 15/08

(52) U.S. Cl. CPC G03G 15/0889; G03G 15/0875; G03G 15/0891; G03G 2215/068; G03G 2215/0819; G03G 2215/085

(57) ABSTRACT

A developing device includes a developer holder that holds a developer containing toner and carrier and being supplied to an image holder forming an electrostatic latent image; and a conveyance section that agitates and conveys the developer flowing in from an inlet using a rotation member to cause the developer to flow out toward the developer holder at an outlet, that includes, as a part constituting a portion of the rotation member, a first blade part for conveyance to the outlet and a second blade part for conveyance in a direction opposite to the outlet, and in which a greater amount of the developer flows in from the inlet than the developer flows out from the outlet.

### CROSS-REFERENCE TO RELATED APPLICATIONS

This application is based on and claims priority under 35 USC 119 from Japanese Patent Application No. 2023-163136 filed Sep. 26, 2023.

### BACKGROUND

### (i) Technical Field

The present invention relates to a developing device and an image forming apparatus.

### (ii) Related Art

For example, JP2018-159810A discloses a developing apparatus including a developer carrier that carries a developer containing toner and magnetic carrier; a developer container that extends along a direction parallel to an axial direction of the developer carrier and accommodates a developer to be supplied to the developer carrier; a partition portion that partitions an inside of the developer container into a first conveyance space and a second conveyance space, and that extends along the direction parallel to the axial direction such that a developer can be delivered between the first conveyance space and the second conveyance space from both end sides; an agitating conveyance member that circulates the developer between the first conveyance space and the second conveyance space by agitating and conveying the developer; and a flow rate adjustment unit that adjusts a flow rate of the developer circulated between the first conveyance space and the second conveyance space, in which the developer container has a first part corresponding to the developer carrier and a second part that protrudes in the direction parallel to the axial direction from the first part, the partition portion of a part positioned in the second part is provided with an opening portion for causing the first conveyance space and the second conveyance space to communicate with each other and for circulating the developer in the second part, the second conveyance space has a region facing the opening portion, and an adjacent region that is on a downstream side of the region in a conveyance direction in which the agitating conveyance member conveys the developer to be adjacent to the region, and the flow rate adjustment unit adjusts the flow rate of the developer circulated in the second part through the opening portion by adjusting the amount of the developer passing through the adjacent region in response to the fluctuation in the amount of toner.

### SUMMARY

Here, the amount of the developer containing toner and carrier in the developing device fluctuates depending on a toner consumption amount or the like. In a case where the amount of the developer fluctuates, a charge amount of toner and a supply amount of toner to a developer holder become unstable, and there may be quality deterioration such as uneven image density. Therefore, a stable supply of the developer to the developer holder is required even in a case where the amount of the developer fluctuates. Therefore, a configuration is considered in which, when the toner consumption amount is increased, for example, the amount of the developer in the developing device is increased by control using a detection result of a detection section to realize a stable supply. However, in a case where such a configuration is adopted, the configuration is complicated.

Aspects of non-limiting embodiments of the present disclosure relate to a developing device and an image forming apparatus that stably supply the developer to the developer holder with a simple configuration even in a case where a consumption amount of the developer increases, as compared with a case where the amount of the developer is increased by control when the consumption amount of the developer containing toner and carrier is increased.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing device including a developer holder that holds a developer containing toner and carrier and being supplied to an image holder forming an electrostatic latent image; and a conveyance section that agitates and conveys the developer flowing in from an inlet using a rotation member to cause the developer to flow out toward the developer holder at an outlet, that includes, as a part constituting a portion of the rotation member, a first blade part for conveyance to the outlet and a second blade part for conveyance in a direction opposite to the outlet, and in which a greater amount of the developer flows in from the inlet than the developer flows out from the outlet.

### BRIEF DESCRIPTION OF THE DRAWINGS

Exemplary embodiment(s) of the present invention will be described in detail based on the following figures, wherein:

FIG. 1 is a diagram illustrating an image forming apparatus;

FIG. 2 is a schematic front view illustrating a developing device of the image forming apparatus;

FIG. 3 is a schematic plan view illustrating the developing device of the image forming apparatus;

FIG. 4 is a diagram illustrating a relationship between a conveying force by a blade portion and a conveying force by a blade portion;

FIG. 5A is a diagram illustrating an example of a position of the blade portion with respect to an inlet, and FIG. 5B is a diagram illustrating another example of the position of the blade portion with respect to the inlet;

FIG. 6 is a diagram illustrating a developing device according to a first exemplary embodiment; and

FIG. 7 is a diagram illustrating a developing device according to a second exemplary embodiment.

### DETAILED DESCRIPTION

Hereinafter, exemplary embodiments of the invention will be described in detail with reference to the accompanying drawings.

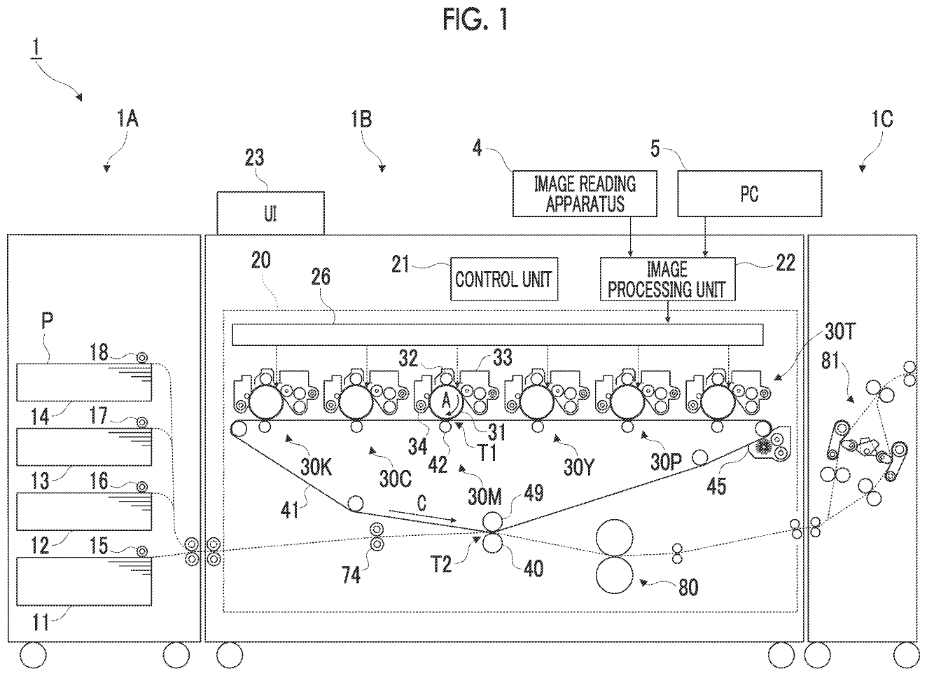

FIG. 1 is a diagram illustrating an image forming apparatus 1.

The image forming apparatus 1 according to the present exemplary embodiment includes a paper feeding unit 1A, a printing unit 1B, and a paper discharge unit 1C.

The paper feeding unit 1A includes a first paper accommodation portion 11 to a fourth paper accommodation portion 14 that accommodate paper P as an example of a recording medium.

In addition, the paper feeding unit 1A is provided with feeding rolls 15 to 18 that are provided respectively corresponding to the first paper accommodation portion 11 to the fourth paper accommodation portion 14, and that feed the paper P accommodated in each paper accommodation portion to a conveyance route connected to the printing unit 1B.

The printing unit 1B includes an image forming portion 20 that forms an image on the paper P. In addition, the printing unit 1B is provided with a control unit 21 that controls each unit of the image forming apparatus 1.

In addition, the printing unit 1B also includes an image processing unit 22. The image processing unit 22 performs image processing on image data transmitted from an image reading apparatus 4 and a personal computer (PC) 5.

In addition, the printing unit 1B is provided with a user interface (UI) 23 that is configured by a touch panel or the like and that notifies a user of information and receives an input of information from the user.

The image forming portion 20 as an example of an image forming section is provided with six image forming units 30T, 30P, 30Y, 30M, 30C, and 30K (hereinafter simply referred to as “image forming unit 30”) arranged in parallel at regular intervals.

Each image forming unit 30 includes a photosensitive drum 31 on which an electrostatic latent image is formed while rotating in a direction of arrow A, a charging roll 32 that charges a surface of the photosensitive drum 31, a developing device 33 that develops the electrostatic latent image formed on the photosensitive drum 31, and a drum cleaner 34 that removes toner or the like on the surface of the photosensitive drum 31.

The photosensitive drum 31 is an example of an image holder.

In addition, the image forming portion 20 is provided with a laser exposure device 26 that exposes each photosensitive drum 31 of each image forming unit 30 with laser light.

Note that the exposure of the photosensitive drum 31 by the laser exposure device 26 is not limited to using laser light. For example, each image forming unit 30 may be provided with a light source such as a light emitting diode (LED), and the exposure of the photosensitive drum 31 may be performed using light emitted from the light source.

The respective image forming units 30 have a similar configuration except for the toner housed in the developing device 33. The image forming units 30Y, 30M, 30C, and 30K form yellow (Y), magenta (M), cyan (C), and black (K) toner images, respectively.

In addition, the image forming units 30T and 30P form toner images using toner corresponding to corporate colors, foamed toner for braille, fluorescent toner, toner to improve glossiness, and the like. In other words, the image forming units 30T and 30P form toner images using special color toner.

In addition, the image forming portion 20 is provided with an intermediate transfer belt 41 to which the toner image of each color formed on the photosensitive drum 31 of each image forming unit 30 is transferred.

In addition, the image forming portion 20 is provided with a primary transfer roll 42 that transfers each color toner image of each image forming unit 30 onto the intermediate transfer belt 41 at a primary transfer portion T1.

In addition, the image forming portion 20 is provided with a secondary transfer roll 40 that transfers the toner images transferred onto the intermediate transfer belt 41 all at once onto the paper P at a secondary transfer portion T2.

Further, the image forming portion 20 is provided with a belt cleaner 45 that removes toner or the like on the surface of the intermediate transfer belt 41, and a fixing device 80 that fixes the secondarily transferred image onto the paper P.

The developing device 33 is an example of a developing section, the intermediate transfer belt 41 is an example of a transfer section, and the fixing device 80 is an example of a fixing section.

The image forming portion 20 performs an image forming operation on the basis of a control signal from the control unit 21.

Specifically, in the image forming portion 20, first, image processing is performed by the image processing unit 22 on the image data input from the image reading apparatus 4 or the PC 5, and the image data after the image processing is performed is supplied to the laser exposure device 26.

Then, for example, in the image forming unit 30M for magenta (M), after the surface of the photosensitive drum 31 is charged by the charging roll 32, the photosensitive drum 31 is irradiated by the laser exposure device 26 with the laser light modulated with the image data obtained from the image processing unit 22.

In this manner, the electrostatic latent image is formed on the photosensitive drum 31.

The formed electrostatic latent image is developed by the developing device 33, and a magenta toner image is formed on the photosensitive drum 31.

Similarly, in the image forming units 30Y, 30C, and 30K, yellow, cyan, and black toner images are formed, and in the image forming units 30T and 30P, special color toner images are formed.

Each color toner image formed in each image forming unit 30 is sequentially electrostatically transferred by the primary transfer roll 42, onto the intermediate transfer belt 41 that rotates in a direction of arrow C in FIG. 1, and superimposed toner images are formed on the intermediate transfer belt 41.

The superimposed toner images formed on the intermediate transfer belt 41 are conveyed to the secondary transfer portion T2 that is configured by the secondary transfer roll 40 and a backup roll 49, as the intermediate transfer belt 41 is moved.

On the other hand, the paper P is taken out from the first paper accommodation portion 11 by, for example, the feeding roll 15, and then is conveyed to a position of a registration roll 74 via the conveyance route.

In a case where the superimposed toner images are conveyed to the secondary transfer portion T2, the paper P is supplied from the registration roll 74 to the secondary transfer portion T2 at the same time.

Then, at the secondary transfer portion T2, the superimposed toner images are electrostatically transferred all at once onto the paper P by the action of a transfer electric field formed between the secondary transfer roll 40 and the backup roll 49.

Thereafter, the paper P on which the superimposed toner images have been electrostatically transferred is conveyed to the fixing device 80.

In the fixing device 80, the paper P on which the unfixed toner image is formed is pressurized and heated, and fixing processing of the toner image on the paper P is performed.

Then, the paper P on which the fixing processing has been performed is conveyed to a paper stacking portion (not illustrated) after passing through a curl correction portion 81 provided in the paper discharge unit 1C.

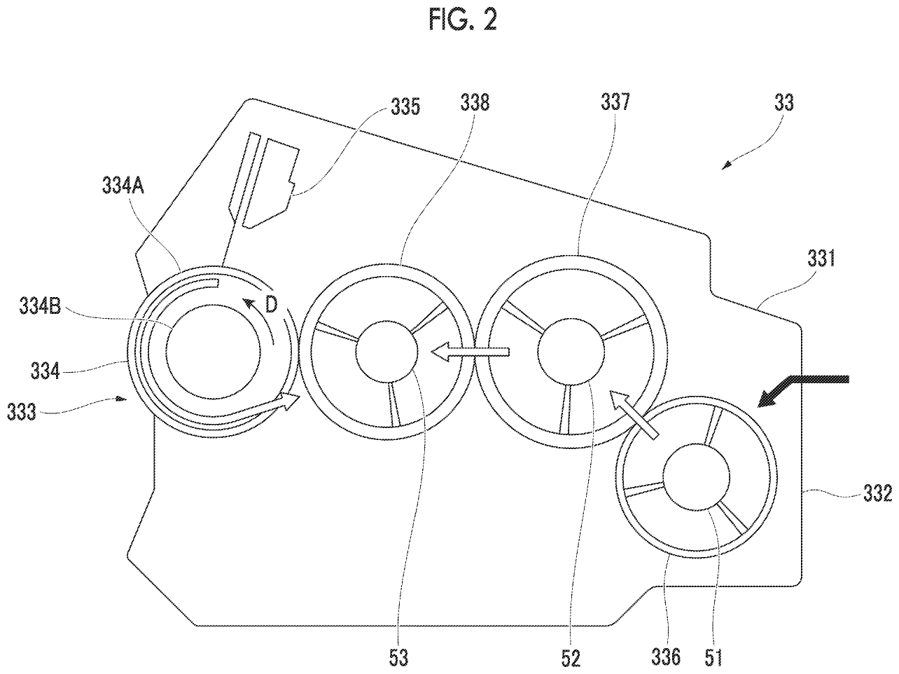

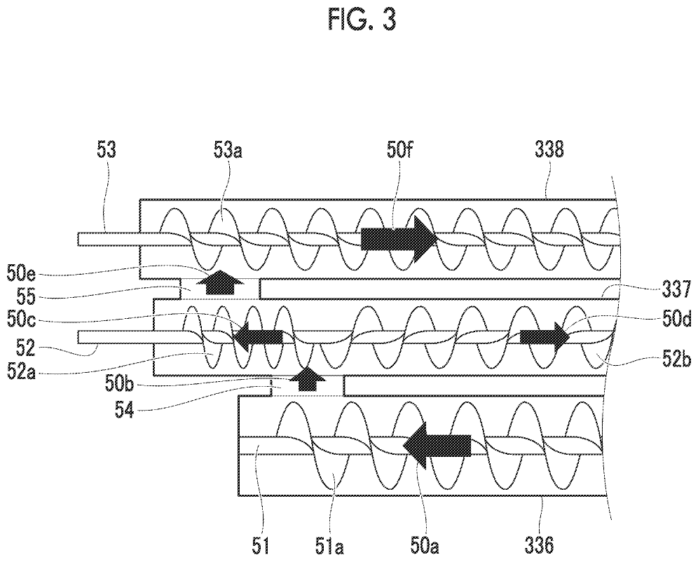

FIGS. 2 and 3 are diagrams illustrating the developing device 33 of the image forming apparatus 1, FIG. 2 is a schematic front view in a case where the developing device 33 is viewed from the same direction as the direction illustrated in FIG. 1, and FIG. 3 is a schematic plan view in a case where the developing device 33 is viewed from above.

As illustrated in FIG. 2, the developing device 33 includes an accommodation portion 331 that accommodates a developer (not illustrated) therein. The accommodation portion 331 is configured by an accommodation case 332 made of resin. Such a developer is configured by magnetic carrier and colored toner, and is a so-called two-component developer.

The accommodation case 332 of the developing device 33 is arranged to extend along a direction perpendicular to the paper surface of FIG. 2, which is a direction from the front side to the rear side of the image forming apparatus 1 (refer to FIG. 1), and has a front side member (not illustrated) on the front side and a rear side member (not illustrated) on the rear side.

The accommodation case 332 is provided with an opening portion 333 at a location facing the photosensitive drum 31 (refer to FIG. 1). A developing roll 334 that attaches the developer to the surface of the photosensitive drum 31 is provided in the opening portion 333. The developing roll 334 holds the developer to be supplied to the photosensitive drum 31. A position at which the developer of the developing roll 334 is supplied to the photosensitive drum 31 is sometimes referred to as a developing position.

The developing roll 334 as an example of the developer holder is formed in a cylindrical shape, and is arranged to extend along the direction from the front side to the rear side of the image forming apparatus 1. Additionally, the developing roll 334 is arranged along a longitudinal direction of the developing device 33.

The developing roll 334 is provided with a developing sleeve 334A configured by a cylindrical body and rotationally driven, and with a magnet roll 334B arranged inside the developing sleeve 334A.

The developing sleeve 334A is configured by metal such as SUS, for example. In addition, the developing sleeve 334A rotates in a direction of arrow D in the figure.

Further, in the present exemplary embodiment, the developing sleeve 334A and the photosensitive drum 31 rotate such that the developing sleeve 334A and the photosensitive drum 31 are moved in the same direction at the primary transfer portion T1 (refer to FIG. 1) between the developing roll 334 and the photosensitive drum 31.

The developing device 33 is provided with a layer regulating member 335 that regulates a layer thickness of the developer held on the developing roll 334.

In addition, as illustrated in FIG. 2, the developing device 33 is provided with a first conveyance portion 336, a second conveyance portion 337, and a third conveyance portion 338 that convey the developer. Hereinafter, the first conveyance portion 336, the second conveyance portion 337, and the third conveyance portion 338 may be referred to as conveyance portions 336 to 338.

The conveyance portions 336 to 338 are provided on a side opposite to the side where the photosensitive drum 31 (refer to FIG. 1) is installed with respect to the developing roll 334. The conveyance portions 336 to 338 respectively include rotation members 51, 52, and 53 extending along the rotation axis of the developing sleeve 334A, which is rotationally driven, and rotate around the rotation members 51, 52, and 53. That is, the conveyance portions 336 to 338 are arranged substantially parallel to the photosensitive drum 31 (refer to FIG. 1).

Note that the first conveyance portion 336 and the second conveyance portion 337 are different in height, that is, different in position in the up-down direction. That is, the developer from the first conveyance portion 336 is conveyed to the second conveyance portion 337 positioned above the first conveyance portion 336. A so-called vertical conveyance path is configured.

Additionally, the developing device 33 according to the present exemplary embodiment includes the vertical conveyance path described above, but a configuration without the vertical conveyance path is also conceivable. In addition, as the vertical conveyance path, a case where the second conveyance portion 337 is positioned above the first conveyance portion 336 is illustrated, but a case where the second conveyance portion 337 is positioned below the first conveyance portion 336 is also conceivable.

As illustrated in FIG. 3, the rotation member 51 of the first conveyance portion 336 includes a spiral blade portion 51a in the axial direction. As the rotation member 51 rotates, the developer is agitated and conveyed by the blade portion 51a.

The rotation member 52 of the second conveyance portion 337 includes a spiral blade portion 52a in the axial direction, and rotates to agitate and convey the developer. The rotation member 53 of the third conveyance portion 338 includes a spiral blade portion 53a in the axial direction, and rotates to agitate and convey the developer.

The developer in the accommodation portion 331 is supplied to the developing roll 334 through a conveyance route in which the developer is conveyed in the order of the first conveyance portion 336, the second conveyance portion 337, and the third conveyance portion 338.

Such supply to the developing roll 334 is realized by the developer being moved in a conveyance direction 50a (left direction in the same figure) in the first conveyance portion 336. In addition, the supply to the developing roll 334 is realized by the developer being moved in a conveyance direction 50c (left direction in the same figure) in the second conveyance portion 337. Further, the supply to the developing roll 334 is realized by the developer being moved in a conveyance direction 50f (right direction in the same figure) in the third conveyance portion 338.

The conveyance directions 50a and 50c are the same directions, and the conveyance direction 50f is a direction opposite to the conveyance directions 50a and 50c. The conveyance direction 50a is an example of a direction of the conveyance by another rotation member, and the conveyance direction 50c is an example of a direction of the conveyance by the rotation member.

The second conveyance portion 337 is connected to the first conveyance portion 336 through an inlet 54 provided on the downstream side in the conveyance direction (left end side in the same figure) by the blade portion 51a of the first conveyance portion 336. In addition, the second conveyance portion 337 is connected to the third conveyance portion 338 through an outlet 55 provided on the downstream side in the conveyance direction by the blade portion 52a of the second conveyance portion 337.

The inlet 54 is a connection portion that connects the first conveyance portion 336 and the second conveyance portion 337 to each other, and the outlet 55 is a connection portion that connects the second conveyance portion 337 and the third conveyance portion 338 to each other.

In this manner, the conveyance route of the developer to the developing roll 334 is formed.

The developer in the first conveyance portion 336 advances in an inflow direction 50b at the inlet 54, and flows into the second conveyance portion 337. In addition, the developer in the second conveyance portion 337 advances in an outflow direction 50e at the outlet 55, and flows out to the third conveyance portion 338.

In more detail, the rotation member 52 of the second conveyance portion 337 includes the blade portion 52a for conveying the developer in the above-mentioned conveyance direction 50c, that is, in a direction from the inlet 54 to the outlet 55. In addition, the rotation member 52 has a blade portion 52b for conveying the developer in a conveyance direction 50d as a direction opposite to the conveyance direction 50c, that is, in a direction away from the outlet 55. Note that the conveyance direction 50c can be referred to as a main direction, and the conveyance direction 50d can be referred to as a sub-direction. The conveyance direction 50d is an example of a direction opposite to the outlet.

In this manner, the rotation member 52 includes the blade portion 52a for the conveyance to the outlet 55, and the blade portion 52b for the conveyance in a direction opposite to the outlet 55.

As described above, in the second conveyance portion 337, the rotation member 52 is configured such that the conveyance direction is split into two directions.

The second conveyance portion 337 is an example of a conveyance section, the rotation member 52 is an example of the rotation member, and the rotation member 51 is an example of another rotation member. In addition, the blade portion 52a is an example of a first blade part, and the blade portion 52b is an example of a second blade part.

Here, an inflow developer that is the developer flowing into the second conveyance portion 337 through the inlet 54, and an outflow developer that is the developer flowing out to the third conveyance portion 338 through the outlet 55 will be described.

In the present exemplary embodiment, in the second conveyance portion 337, in a case where the amount of the inflow developer and the amount of the outflow developer are compared with each other, the amounts are not the same, and the amount of the inflow developer is greater than the amount of the outflow developer. That is, a greater amount of the inflow developer than the outflow developer flowing out from the outlet 55 flows in from the inlet 54.

In more detail, the outflow developer in the second conveyance portion 337 is conveyed in the conveyance direction 50c by the blade portion 52a of the rotation member 52, and the remaining developer obtained by subtracting the amount of the outflow developer from the amount of the inflow developer is conveyed in the conveyance direction 50d by the blade portion 52b of the rotation member 52.

Note that, in the present exemplary embodiment, the conveyance direction 50a by the blade portion 51a of the first conveyance portion 336 and the conveyance direction 50c by the blade portion 52a of the second conveyance portion 337 are the same direction, but the present disclosure is not limited thereto, and the conveyance direction 50a and the conveyance direction 50c may be different directions.

Additionally, as in the present exemplary embodiment, in a case where the conveyance directions 50a and 50c are the same direction, since the developer conveyed by the blade portion 52a in the second conveyance portion 337 is conveyed in the conveyance direction 50c using the inertia force in a case of being conveyed in the conveyance direction 50a, the developer can stably flow out from the outlet 55 to the third conveyance portion 338.

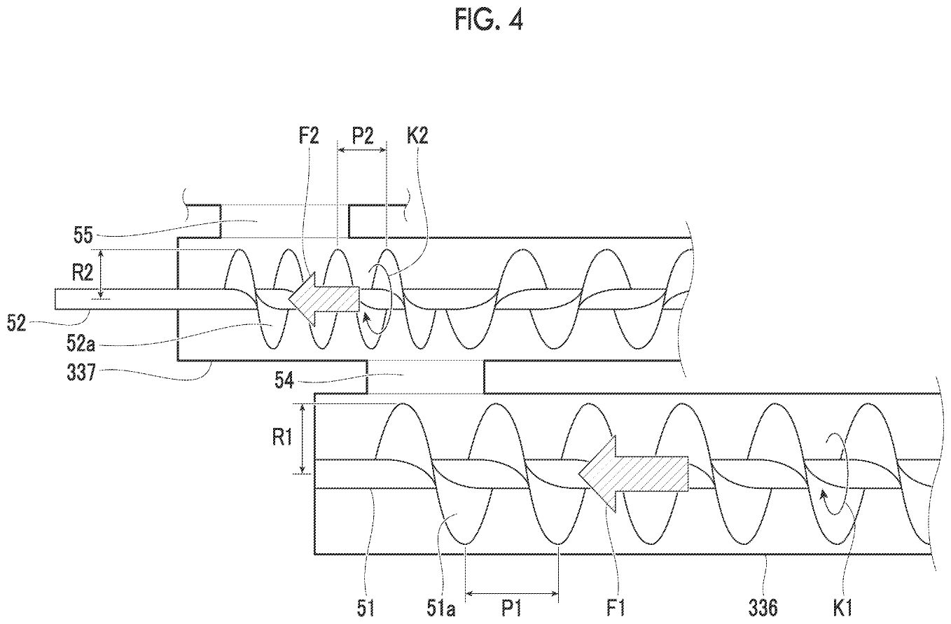

Here, a relationship between a conveying force F1 in a case where the developer is conveyed by the blade portion 51a of the first conveyance portion 336 and a conveying force F2 in a case where the developer is conveyed by the blade portion 52a of the second conveyance portion 337 will be described using FIG. 4.

FIG. 4 is a diagram illustrating the relationship between the conveying force F1 by the blade portion 51a and the conveying force F2 by the blade portion 52a.

As illustrated in FIG. 4, the developer in the first conveyance portion 336 is conveyed to the inlet 54 by the conveying force F1 by the blade portion 51a. In addition, in the second conveyance portion 337, the developer is conveyed to the outlet 55 by the conveying force F2 by the blade portion 52a. In such a case, the conveying force F1 is greater than the conveying force F2 (F1>F2). The difference in conveying force together with the above-mentioned split of the conveyance directions in the second conveyance portion 337 enables a stable supply of the developer to the developing roll 334.

In a case where the conveying force F1 is lower than the conveying force F2 or in a case where the conveying force F1 and the conveying force F2 are the same, the amount of the developer flowing out from the outlet 55 to the third conveyance portion 338 gradually decreases, which becomes difficult to obtain the stable supply.

The conveying force F1 here is determined by at least one of the size of a pitch P1, a radius R1, or a rotation speed K1 during the conveyance of the blade portion 51a. In addition, the conveying force F2 is determined by at least one of the size of a pitch P2, a radius R2, or a rotation speed K2 during the conveyance of the blade portion 52a.

For example, in a case where the rotation speeds of the blade portions 51a and 52a during the conveyance are the same (K1=K2), the size of the pitch P1 and the radius R1 of the blade portion 51a are configured to be greater than the size of the pitch P2 and the radius R2 of the blade portion 52a (P1>P2, R1>R2). In addition, in a case where the rotation speeds during the conveyance and the pitches P1 and P2 of the blade portions 51a and 52a are the same (K1=K2, P1=P2), the radius R1 of the blade portion 51a is configured to be greater than the radius R2 of the blade portion 52a (R1>R2). Further, in a case where the size of the pitch P1 and the radius R1 of the blade portion 51a and the size of the pitch P2 and the radius R2 of the blade portion 52a are the same (P1=P2, R1=R2), the rotation speed K1 of the blade portion 51a during the conveyance is set to be greater than the rotation speed K2 of the blade portion 52a (K1>K2).

Note that, in the present exemplary embodiment, the blade portion 52a and the blade portion 52b are provided on one rotation member 52, but the present disclosure is not limited thereto. Although not illustrated, for example, the blade portion 52a may be provided on the rotation member 52, and the blade portion 52b may be provided on a rotation member different from the rotation member 52. In such a case, the rotation speed of the blade portion 52a and the rotation speed of the blade portion 52b can be set to different values. Note that, for example, in such a case, the rotation member 52 and another rotation member are preferably provided coaxially.

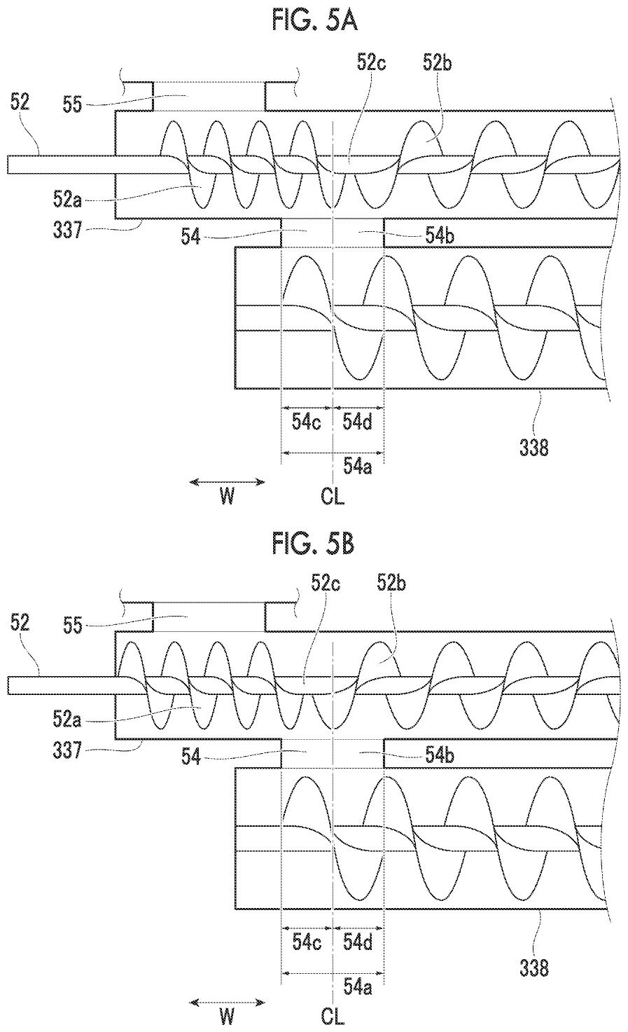

Here, the position of the blade portion 52a with respect to the inlet 54 will be described using FIGS. 5A and 5B.

FIG. 5A is a diagram illustrating an example of the position of the blade portion 52a with respect to the inlet 54, and FIG. 5B is a diagram illustrating another example of the position of the blade portion 52a with respect to the inlet 54.

As illustrated in FIGS. 5A and 5B, an end portion 52c of the blade portion 52a is positioned within an opening range of the inlet 54. That is, the end portion 52c is positioned in a region 54b corresponding to a width 54a of the inlet 54.

By adopting such a configuration, excess or shortage of the developer to be conveyed to the outlet 55 is prevented as compared with a case where the end portion 52c is not positioned in the region 54b. That is, the amount of the developer conveyed to the outlet 55 is increased as compared with a case where the end portion 52c is positioned closer to the outlet 55 than to the region 54b. In addition, the amount of the developer conveyed to the outlet 55 is prevented from being excessive as compared with a case where the end portion 52c is positioned closer to a side opposite to the outlet 55 from the region 54b.

The region 54b here is a region of the rotation member 52 corresponding to the width 54a of the inlet 54. In addition, the end portion 52c here refers to an end portion farthest from the outlet 55 among both end portions of the blade portion 52a in the axial direction. The end portion 52c is an example of an end portion of the first blade part, the end portion being far from the outlet.

In addition, in a case where the region 54b is divided into two by a center line CL in a width direction W at the inlet 54, a side closer to the outlet 55 is defined as a region 54c, and a side farther from the outlet 55 is defined as a region 54d. The center line CL is an example of the center in the width direction.

In the example illustrated in FIG. 5A, the end portion 52c of the blade portion 52a is positioned in the region 54d. That is, the end portion 52c far from the outlet 55 is positioned on a side far from the outlet 55. In this manner, the amount of the developer conveyed to the outlet 55 is increased. In particular, the configuration is useful in the case of the above-mentioned vertical conveyance path (refer to FIG. 2).

On the other hand, in another example illustrated in FIG. 5B, the end portion 52c is positioned in the region 54c. That is, the end portion 52c far from the outlet 55 is positioned on a side closer to the outlet 55. In this manner, the amount of the developer conveyed to the outlet 55 is prevented from being excessive.

As described above, the present exemplary embodiment adopts the configuration in which the flow rate of the inflow developer from the inlet 54 (for example, refer to FIG. 3) is greater than the flow rate of the outflow developer from the outlet 55 (refer to the same figure). The second conveyance portion 337 includes the blade portion 52a that conveys the developer in the conveyance direction 50c as a direction in which the inflow developer is conveyed toward the outlet 55, and the blade portion 52b that conveys the developer in the conveyance direction 50d as a direction opposite to the conveyance direction 50c (refer to FIG. 3). Further, the blade portion 52a is arranged at a position spanning the width of the inlet 54. In this manner, the stable supply of the developer to the developing roll 334 is obtained.

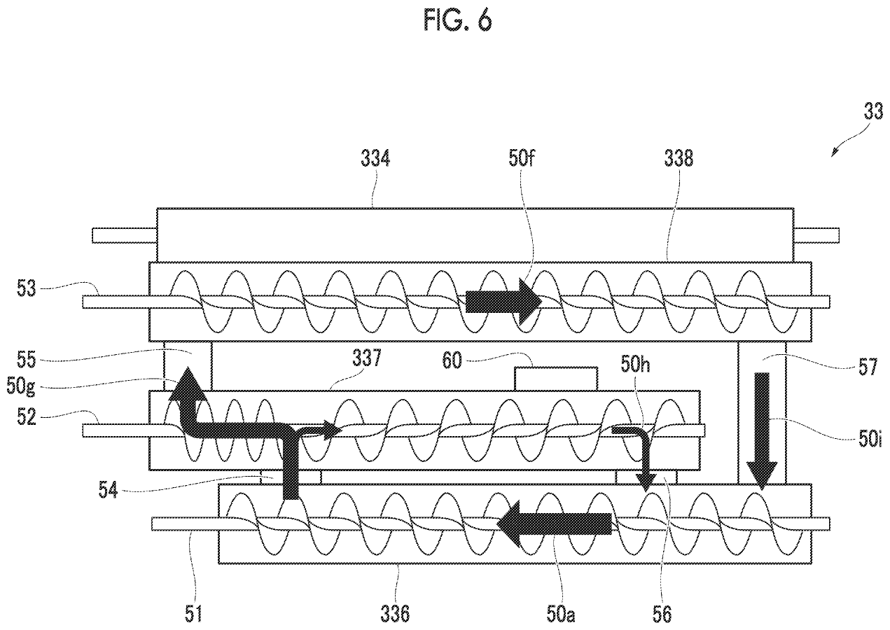

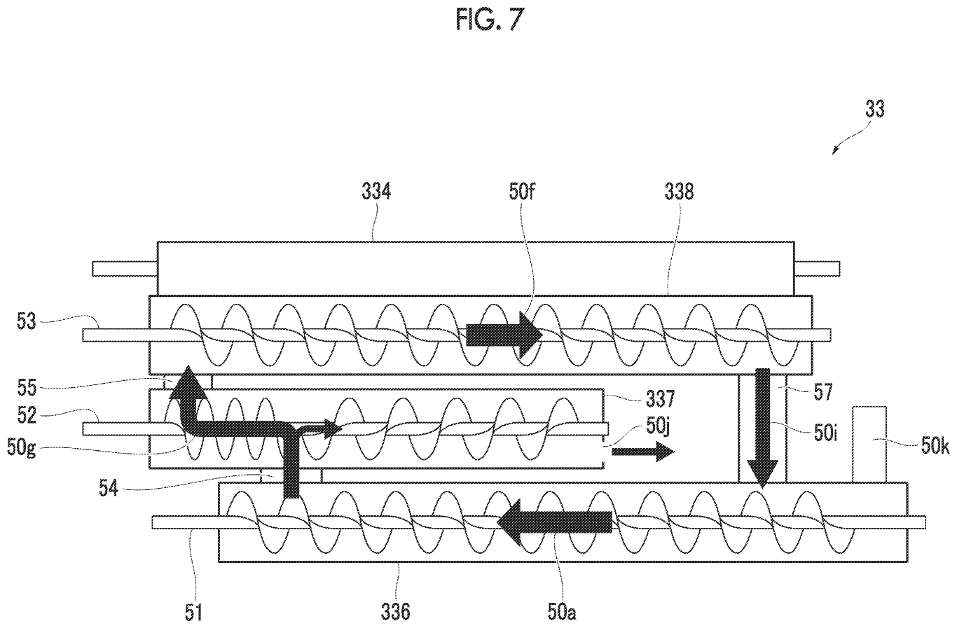

Next, a first exemplary embodiment and a second exemplary embodiment to which the present exemplary embodiment is applied will be described using FIGS. 6 and 7. Note that, in FIGS. 6 and 7, the same reference numerals are used for the members described in the present exemplary embodiment, and the description thereof may be omitted.

### First Exemplary Embodiment

FIG. 6 is a diagram illustrating the developing device 33 according to the first exemplary embodiment.

In the developing device 33 according to the first exemplary embodiment illustrated in FIG. 6, the developer flowing from the first conveyance portion 336 to the second conveyance portion 337 through the inlet 54 flows in two directions as indicated by a conveyance direction 50g. A part of the divided developer flows from the outlet 55 to the third conveyance portion 338. The remaining developer returns to the upstream side of the first conveyance portion 336 from the second conveyance portion 337 through a return port 56.

Note that, as indicated by the conveyance direction 50g, the amount of the developer flowing out from the outlet 55 is greater than the remaining developer.

That is, as described above, in a case where the amount of the inflow developer and the amount of the outflow developer in the second conveyance portion 337 are compared with each other, the amounts are not the same and are different from each other, and more specifically, the amount of the inflow developer is greater than the amount of the outflow developer. Then, the difference returns to the first conveyance portion 336. In this manner, the amount of the developer supplied to the third conveyance portion 338 from the outlet 55 becomes stable.

In addition, the developer that has not been supplied to the developing roll 334 among the developer that has been conveyed to the third conveyance portion 338 returns to the first conveyance portion 336 from a return port 57 positioned at a downstream end in the conveyance direction 50f. In this manner, the developer can be stably supplied from the third conveyance portion 338 to the developing roll 334.

In more detail, in the first exemplary embodiment, there are provided a detection unit 60 that is positioned on the downstream side of the second conveyance portion 337 and detects the amount of the developer, and a shutter portion (not illustrated) of which the opening/closing is controlled on the basis of a detection result of the detection unit 60.

When the detection result of the detection unit 60 indicates that the amount of the developer does not exceed a predetermined value, the shutter (not illustrated) is closed, and when the detection result of the detection unit 60 indicates that the amount of the developer exceeds the predetermined value, the shutter (not illustrated) is opened so that the developer returns to the third conveyance portion 338 from the return port 57.

### Second Exemplary Embodiment

FIG. 7 is a diagram illustrating the developing device 33 according to the second exemplary embodiment. Note that the description of parts common to the first exemplary embodiment may be omitted.

In the developing device 33 according to the second exemplary embodiment illustrated in FIG. 7, the developer in the second conveyance portion 337 that does not flow out to the third conveyance portion 338 from the outlet 55 is discharged outside the device from a discharge port 50j positioned on a downstream end. In this manner, the amount of the developer can be prevented from being excessive.

Meanwhile, a new developer is supplied to the first conveyance portion 336 through a supply port 50k. By supplying the new developer from the supply port 50k, an increase or decrease in the amount of the developer in the developing device 33 is suppressed, and the image density is stabilized.

Note that the second exemplary embodiment may include the above-described detection unit 60 and shutter (not illustrated) included in the first exemplary embodiment.

### Supplementary Note

(((1)))

A developing device comprising:
a developer holder that holds a developer containing toner and carrier and being supplied to an image holder forming an electrostatic latent image; and
a conveyance section that agitates and conveys the developer flowing in from an inlet using a rotation member to cause the developer to flow out toward the developer holder at an outlet, that includes, as a part constituting a portion of the rotation member, a first blade part for conveyance to the outlet and a second blade part for conveyance in a direction opposite to the outlet, and in which a greater amount of the developer flows in from the inlet than the developer flows out from the outlet.
(((2)))

The developing device according to (((1))),
wherein an end portion of the first blade part, which is far from the outlet, is positioned in a region corresponding to a width of the inlet.
(((3)))

The developing device according to (((2))),
wherein the end portion far from the outlet is positioned on a side far from the outlet in a case where the region is divided into two by a center in a width direction at the inlet.
(((4))

The developing device according to (((2))),
wherein the end portion far from the outlet is positioned on a side close to the outlet in a case where the region is divided into two by a center in a width direction at the inlet.
(((5)))

The developing device according to any one of (((1))) to (((4))),
wherein the developer flowing to the inlet is conveyed by a conveyance route by another rotation member of the conveyance section different from the rotation member, and
a direction of the conveyance by the other rotation member is the same as a direction of the conveyance by the rotation member.
(((6)))

The developing device according to any one of (((1))) to (((4))),
wherein the developer flowing to the inlet is conveyed by a conveyance route by another rotation member of the conveyance section different from the rotation member, and
a conveying force for the conveyance by the other rotation member is greater than a conveying force of the first blade part.
(((7)))

The developing device according to (((6))),
wherein a magnitude of the conveying force is determined by at least one of a size of a pitch of blades, a size of a radius of the blades, or a magnitude of a rotation speed during the conveyance.
(((8)))

The developing device according to (((5))) or (((6))),
wherein the developer conveyed by the second blade part is able to be discharged.
(((9)))

An image forming apparatus comprising:
an image holder that forms an electrostatic latent image;
a developing section that develops the electrostatic latent image formed on the image holder into a toner image;
a transfer section that transfers the toner image by the developing section onto a recording material; and
a fixing section that fixes the toner image transferred onto the recording material to the recording material,
wherein the developing section includes
a developer holder that holds a developer containing toner and carrier and being supplied to the image holder forming the electrostatic latent image, and
a conveyance section that agitates and conveys the developer flowing in from an inlet using a rotation member to cause the developer to flow out toward the developer holder at an outlet, that includes, as a part constituting a portion of the rotation member, a first blade part for conveyance to the outlet and a second blade part for conveyance in a direction opposite to the outlet, and in which a greater amount of the developer flows in from the inlet than the developer flows out from the outlet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a developer holder that holds a developer containing toner and carrier and being supplied to an image holder forming an electrostatic latent image; and
a conveyance section that agitates and conveys the developer flowing in from an inlet using a rotation member to cause the developer to flow out toward the developer holder at an outlet, that includes, as a part constituting a portion of the rotation member, a first blade part for conveyance to the outlet and a second blade part for conveyance in a direction opposite to the outlet, and in which a greater amount of the developer flows in from the inlet than the developer flows out from the outlet.

2. The developing device according to claim 1,
wherein an end portion of the first blade part, which is far from the outlet, is positioned in a region corresponding to a width of the inlet.

3. The developing device according to claim 2,
wherein the end portion far from the outlet is positioned on a side far from the outlet in a case where the region is divided into two by a center in a width direction at the inlet.

4. The developing device according to claim 2,
wherein the end portion far from the outlet is positioned on a side close to the outlet in a case where the region is divided into two by a center in a width direction at the inlet.

5. The developing device according to claim 1,
wherein the developer flowing to the inlet is conveyed by a conveyance route by another rotation member of the conveyance section different from the rotation member, and
a direction of the conveyance by the other rotation member is the same as a direction of the conveyance by the rotation member.

6. The developing device according to claim 1,
wherein the developer flowing to the inlet is conveyed by a conveyance route by another rotation member of the conveyance section different from the rotation member, and
a conveying force for the conveyance by the other rotation member is greater than a conveying force of the first blade part.

7. The developing device according to claim 6,
wherein a magnitude of the conveying force is determined by at least one of a size of a pitch of blades, a size of a radius of the blades, or a magnitude of a rotation speed during the conveyance.

8. The developing device according to claim 5,
wherein the developer conveyed by the second blade part is able to be discharged.

9. The developing device according to claim 6,
wherein the developer conveyed by the second blade part is able to be discharged.

10. An image forming apparatus comprising:
an image holder that forms an electrostatic latent image;
a developing section that develops the electrostatic latent image formed on the image holder into a toner image;
a transfer section that transfers the toner image by the developing section onto a recording material; and
a fixing section that fixes the toner image transferred onto the recording material to the recording material,
wherein the developing section includes
a developer holder that holds a developer containing toner and carrier and being supplied to the image holder forming the electrostatic latent image, and
a conveyance section that agitates and conveys the developer flowing in from an inlet using a rotation member to cause the developer to flow out toward the developer holder at an outlet, that includes, as a part constituting a portion of the rotation member, a first blade part for conveyance to the outlet and a second blade part for conveyance in a direction opposite to the outlet, and in which a greater amount of the developer flows in from the inlet than the developer flows out from the outlet.

11. A developing device comprising:
a developer holder that holds a developer containing toner and carrier and being supplied to an image holder forming an electrostatic latent image; and
conveying means that agitates and conveys the developer flowing in from an inlet using a rotation member to cause the developer to flow out toward the developer holder at an outlet, that includes, as a part constituting a portion of the rotation member, a first blade part for conveyance to the outlet and a second blade part for conveyance in a direction opposite to the outlet, and in which a greater amount of the developer flows in from the inlet than the developer flows out from the outlet.
